(19) United States
(12) Patent Application Publication
(10) Pub. No.: US 2008/0062341 A1
(43) Pub. Date: Mar. 13, 2008

(54) Liquid crystal display device and drive circuit

(75) Inventor: Yoshiyuki Tanaka, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELETRONICS CORPORATION, Kawasaki (JP)

(21) Appl. No.: 11/896,915

(22) Filed: Sep. 6, 2007

(30) Foreign Application Priority Data
Sep. 7, 2006 (JP) 242903/2006

(51) Int. Cl. G02F 1/1343; G09G 3/30

(52) U.S. Cl. 349/38; 345/77

(57) ABSTRACT

A drive circuit of a liquid crystal display device according to the present invention applies drive potentials to common electrodes provided in common for a plurality of pixels of a liquid crystal panel. The drive circuit includes: a panel capacitance detection circuit, which detects the capacitance values of a liquid capacitor and a storage capacitor of the liquid crystal panel; and a drive potential adjustment circuit. In accordance with the capacitance values detected by the panel capacitance detection circuit, the drive potential adjustment circuit sets the drive potentials, which are to be applied to the common electrodes, to vary according to the detected capacitance values.

### BACKGROUND OF THE INVENTION

1. Field of the Invention

The present invention relates to a liquid crystal display device. In particular, the present invention relates to a technique to control a drive potential of a common electrode provided in common for a plurality of pixels in a liquid crystal panel.

2. Description of Related Art

The liquid crystal panel of a liquid crystal display device includes a plurality of pixels arranged in a matrix. FIG. 1 is a diagram schematically showing a configuration of a pixel 1 in an active matrix type liquid crystal display device (refer to Japanese Patent Application Laid-open Publication No. 2004-361758).

The pixel 1 includes a thin film transistor (TFT) 2, a liquid crystal cell (liquid crystal capacitor) LC and a storage capacitor SC. A gate electrode 2a of the TFT 2 is connected to a gate line (scanning line) 3. One of the source electrode and drain electrode of the TFT 2 is connected to a data line (signal line) 4, and the other one is connected to a pixel electrode 5. One end of the pixel electrode 5 is connected to one end of the liquid crystal cell LC, and the other end thereof is connected to one end of the storage capacitor SC. The other end of the liquid crystal cell LC is connected to a first common electrode (opposite electrode) 6. Furthermore, the other end of the storage capacitor SC is connected to a second common electrode 7. The first and second common electrodes 6 and 7 are provided in common for the plurality of pixels 1.

A common electrode potential VCOM 1 is applied to the first common electrode 6. In other words, the common electrode potential VCOM 1 is applied in common to each liquid crystal capacitor LC of the plurality of pixels 1. In addition, a common electrode potential VCOM 2 is applied to the second common electrode 7. In other words, the common electrode potential VCOM 2 is applied in common to each storage capacitor SC of the plurality of pixels 1.

The potential of the gate line 3 changes from a high level to a low level after the potentials in the liquid crystal capacitor LC and the storage capacitor SC are set to the pixel potentials through the TFT 2. At this time, there occurs a phenomenon (feed through) in which the pixel potential decreases due to a voltage division between the gate capacitance of the TFT 2 and the total capacitance of the liquid capacitor and the storage capacitor SC. The direction of the feed through in a pixel driven on the positive side is opposite to that in a pixel driven on the negative side, so that there occurs a phenomenon in which pixel voltages are different between the pixels driven on the positive side and negative sides. This phenomenon is a problem with liquid crystal display devices, which is recognized as a flicker on the screen. In order to prevent such a phenomenon from occurring, it is necessary to lower the potentials of the first and second common electrodes 6 and 7 by the amount equivalent to the amount of feed through (to provide an offset). The smaller the total value of the liquid crystal capacitor LC and the storage capacitor SC, the larger the amount of this feed through.

Japanese Patent Application Laid-open Publication No. 2004-361758 (hereinafter, referred to as Patent Document 1) points out that a variable resistor hinders downsizing the liquid crystal display device while being used a variable register. For this reason, according to the technique disclosed in Patent Document 1, instead of using a variable resistor, a D/A converter is used as means for setting an offset of the common electrode potential VCOM 1. To be more specific, digital data corresponding to a decreasing amount of the potential that is specific to the liquid crystal panel is previously stored in a ROM provided outside a glass substrate. Then, the D/A converter makes an adjustment on the common electrode potential VCOM 1 based on the digital data.

The inventor of the present invention has focused attention on the following points. Data display characteristics of a pixel 1 depend on a load capacitance (liquid crystal capacitor LC or storage capacitor SC) of the TFT2. Accordingly, manufacturing irregularities in liquid capacitors LC or storage capacitors SC cause irregularities of display characteristics. In other words, manufacturing irregularities in liquid crystal panels cause irregularities of display characteristics among liquid crystal panels. Such irregularities in liquid crystal panels invite a reduction in production yields.

One possible technique of suppressing the irregularities of display characteristics among liquid crystal panels is to adjust a potential to be applied to a common electrode. According to the technique disclosed in Patent Document 1, digital data for adjusting an offset of the common electrode potential VCOM 1 is previously determined for each liquid crystal panel. Then, the digital data is stored in a ROM provided outside a glass substrate. The same technique as this can also be applied for the purpose of suppressing the irregularities of display characteristics. In this case, however, it is necessary to determine digital data for each liquid crystal panel in advance and then to store the data in a ROM, so that the number of manufacturing processes increases. In addition, the production efficiency is not good either in this case.

### SUMMARY

Hereinafter, a description will be given of a summary of the invention, with reference numerals used in detailed description of the preferred embodiment. These reference numerals are added herein with parentheses for the purpose of clarifying correspondence relationships between the description in scope of claims and the description in detailed description of the preferred embodiment. These reference numerals, however, must not be used for interpretation of the technical scope of the invention described in scope of claims.

According to a first aspect of the invention, a drive circuit (30) of a liquid crystal display device (10) is provided. The liquid crystal display device (10) includes a liquid crystal panel (20) having a plurality of pixels (1). The drive circuit (30) applies at lest one drive potential (VCOM 1 or VCOM 2) to at lest one common electrode (6 or 7) provided in common for the plurality of pixels (1) of the liquid crystal panel (20). To be more specific, the drive circuit (30) according to the present invention includes: a panel capacitance detection circuit (50), which detects capacitance values of a liquid capacitor (LC) and a storage capacitor (SC) of the liquid crystal panel (20); and a drive potential adjustment circuit (60). In accordance with the capacitance values detected by the panel capacitance detection circuit, the drive potential adjustment circuit (60) sets the drive potential, which are to be applied to the common electrode, to vary according to the detected capacitance values.

As described above, the panel capacitance detection circuit (50), which detects capacitor values of the liquid capacitor (LC) and the storage capacitor (SC) of the liquid crystal panel (20), is embedded in the drive circuit (30) according to the present invention. On the basis of the capacitance values detected by the embedded panel capacitor detection circuit (50), the drive potential to be applied to the common electrode is automatically adjusted. In other words, by implementing in a versatile manner the drive circuit (30) having the aforementioned configuration in the liquid crystal display device (10), the drive potential in each liquid crystal panel (20) can be automatically adjusted. It is not necessary to determine digital data for each liquid crystal panel (20) in advance and then to store the data in a ROM. The drive potential of the common electrode for each liquid crystal panel (20) can be efficiently adjusted without having extra work steps. Since the drive potential of the common electrode is adjusted, the irregularities of the display characteristics among liquid crystal panels (20) can be suppressed. As a result, the production yields improve. In addition, the most appropriate driving of the liquid crystal can be performed.

According to a second aspect of the invention, the liquid crystal display device (10) is provided. The liquid crystal display device (10) includes the aforementioned drive circuit (30), and the liquid crystal panel (20) driven by the drive circuit (30). Specifically, in accordance with, the capacitance values of the liquid crystal capacitor (LC) and the storage capacitor (SC), the drive circuit (30) sets the drive potentials (VCOM 1 and VCOM 2) of the common electrodes (6 and 7), to vary according to the detected capacitance values.

According to a third aspect of the invention, a driver for driving a liquid crystal display, the liquid crystal display including a plurality of pixel elements, each containing a thin film transistor (TFT), a liquid crystal cell coupled to the TFT and a storage capacitor coupled to the TFT, the liquid crystal display further including a first common electrode coupled to the liquid crystal cells of the plurality of pixel elements and a second electrode coupled to the storage capacitors of the plurality of pixel elements, includes: a first terminal receiving a capacitance value of the liquid crystal panel and the storage capacitor; and a second terminal supplying drive voltages to the first and second common electrodes. The drive voltages are adjusted by the capacitance value received at the first terminal.

According to the present invention, a drive potential to be applied to a common electrode of a liquid crystal panel can be automatically adjusted. Accordingly, irregularities of display characteristics among liquid crystal panels can be automatically adjusted. As a result, the production yields improve. In addition, the most appropriate driving of the liquid crystal can be performed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram schematically showing a configuration of a pixel included in a liquid crystal panel,

FIG. 2 is a block diagram showing a configuration of a liquid crystal display device according to an embodiment of the present invention,

FIG. 3A is a cross-sectional view showing a structure of a pixel according to the embodiment of the present invention,

FIG. 3B is a cross-sectional view showing a structure of a capacitor-to-be-detected according to the embodiment of the present invention,

FIG. 4 is a block diagram showing a configuration of a common electrode driver according to the embodiment of the present invention,

FIG. 5 is a block diagram showing a configuration of a drive potential adjustment circuit according to the embodiment of the present invention,

FIG. 6 is a graph showing an example of relationships of an adjustment value (correction value) of a drive potential to be applied to a common electrode, a capacitance value of the capacitor-to-be-detected and a count value,

FIG. 7 is a timing chart showing an operation of the common electrode driver according to the embodiment of the present invention, and

FIG. 8 is a block diagram showing a modification example of the liquid crystal display device according to the embodiment of the present invention.

### DETAILED DESCRIPTION OF THE PREFERRED EMBODIMENT

Hereinafter, a description will be given of a liquid crystal display device according to an embodiment of the present invention with reference to accompanying drawings.

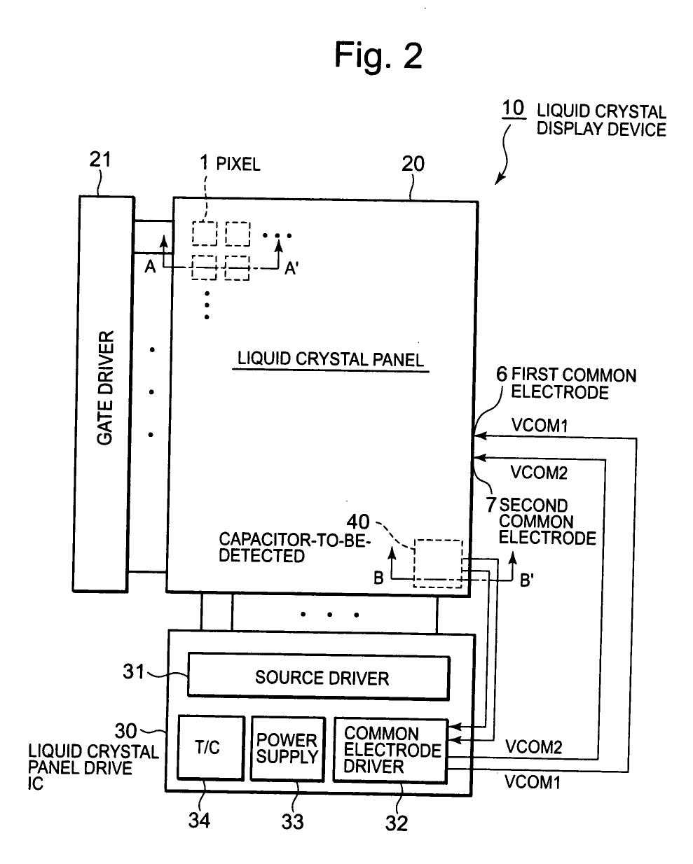

FIG. 2 is a block diagram showing a configuration of an active matrix type liquid crystal display device 10 according to the embodiment of the present invention. The liquid crystal display device 10 is provided with a liquid crystal panel 20, a gate driver 21 and a liquid crystal panel drive IC 30.

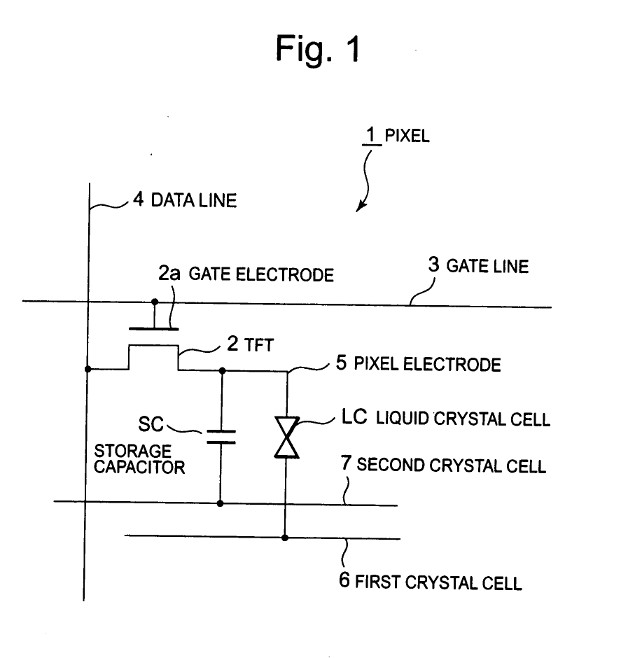

The liquid crystal panel 20 includes a plurality of pixels 1 arranged in a matrix shape. Each of the pixels 1 has a configuration shown in FIG. 1. Specifically, each of the pixels 1 includes a TFT 2, a liquid crystal cell (liquid crystal capacitor) LC and a storage capacitor SC. A gate electrode 2a of the TFT 2 is connected to a gate line 3. One of the source electrode and the drain electrode of the TFT 2 is connected to a data line 4, and the other one is connected to a pixel electrode 5. One end of the pixel electrode 5 is connected to one end of the liquid crystal cell LC, and the other end thereof is connected to one end of the storage capacitor SC. The other end of the liquid crystal cell LC is connected to a first common electrode (opposite electrode) 6. In addition, the other end of the storage capacitor SC is connected to a second common electrode 7. The first and second common electrodes 6 and 7 are provided in common for the plurality of pixels 1. It is to be noted that the potentials of the first and second common electrodes 6 and 7 may be equal to each other.

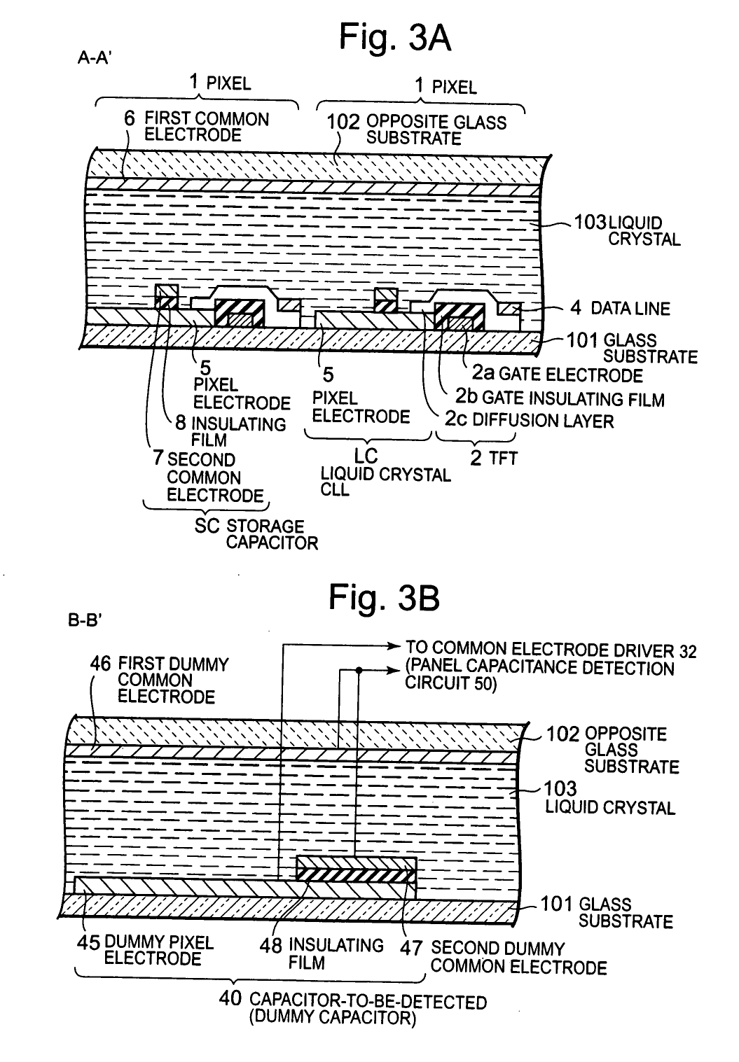

FIG. 3A shows a cross-sectional structure view taken along the line A-A′ in FIG. 2 and indicates an example of the cross-sectional structure of the pixel 1. As shown in FIG. 3A, the liquid crystal panel 20 includes a glass substrate 101 and an opposite glass substrate 102. A liquid crystal 103 is placed between and held by the glass substrate 101 and the opposite substrate 102. The TFT 2 and the pixel electrode 5 are formed on the glass substrate 101. The TFT 2 includes the gate electrode 2a, a gate insulating film 2b formed on the gate electrode 2a, and a diffusion layer 2c formed on the gate insulating film 2b. The diffusion layer 2c is connected to the data line 4 and the pixel electrode 5. The second common electrode 7 is formed on the pixel electrode 5 with an insulating film 8 interposed therebetween. In addition, the first electrode 6 is formed on the opposite glass substrate 102. The liquid crystal capacitor LC is formed of the first common electrode 6, the liquid crystal 103 and the pixel electrode 5. Moreover, the storage capacitor SC is formed of the second common electrode 7, the insulating film 8 and the pixel electrode 5.

With reference to FIG. 2 again, the gate driver 21 is connected to the gate line 3 of the liquid crystal panel 20. The gate driver 21 drives the gate line 3 connected to the pixel 1 that is a display target.

The liquid crystal panel drive IC 30 is an IC for driving the liquid crystal panel 20 and is connected to the liquid crystal panel 20. The liquid crystal panel drive IC 30 shown in FIG. 2 includes a source driver 31, a common electrode driver 32, a power supply 33 and a timing controller (T/C) 34, which are embedded therein. On the basis of a master clock, a horizontal synchronizing signal and a vertical synchronizing signal, the timing controller 34 creates various timing pulses required for operations of various drivers. The source driver 31 is connected to the data line 4 of the liquid crystal panel 20 and drives the data line 4 connected to the pixel 1 that is a display target.

The common electrode driver 32 is connected to the first and second common electrodes 6 and 7 of the liquid crystal panel 20 and drives these first and second common electrodes 6 and 7. To be more specific, the common electrode driver 32 applies drive potentials (common electrode potentials) VCOM 1 and VCOM 2 to the first and second common electrodes 6 and 7, respectively. The drive potential VCOM 1 is applied in common to respective liquid crystal cells LC of the plurality of pixels 1. Moreover, the drive potential VCOM 2 is applied in common to respective storage capacitors SC of the plurality of pixels 1.

Display characteristics of data in the pixel 1 depend on a load capacitance (liquid crystal capacitor LC or storage capacitor SC) of the TFT 2. Accordingly, manufacturing irregularities in liquid crystal capacitors LC or storage capacitors SC cause irregularities of display characteristics. Specifically, manufacturing irregularities in liquid crystal panels 20 cause the irregularities of display characteristics among the liquid crystal panels 20. In order to suppress such irregularities of display characteristics, the drive potentials VCOM 1 and VCOM 2 to be respectively applied to the common electrodes 6 and 7 are adjusted on the basis of capacitance values of the liquid crystal capacitor LC and storage capacitor SC of the liquid crystal panel 20. Specifically, the common electrode driver 32 according to the present embodiment sets, in accordance with the capacitance values of the liquid crystal capacitor LC and storage capacitor SC of the liquid crystal panel 20, the drive potentials VCOM 1 and VCOM 2 to vary.

To be more specific, the common electrode driver 32 includes a function to automatically detect (measure) the capacitance values of the liquid crystal capacitor LC and storage capacitor SC of the liquid crystal panel 20. In order to detect the capacitance values of the liquid crystal capacitor LC and storage capacitor SC of the liquid crystal panel 20, a capacitor-to-be-detected 40 is formed on the glass substrate of the liquid crystal panel 20. This capacitor-to-be-detected 40 is a “dummy capacitor,” which is provided separately from the liquid crystal capacitor LC or storage capacitor of a certain pixel 1.

FIG. 3B shows a cross-sectional structure view taken along the line B-B′ in FIG. 2 and indicates an example of the cross-sectional structure of the capacitor-to-be-detected 40. As shown in FIG. 3B, a dummy pixel electrode 45 is formed on the glass substrate 101. A second dummy common electrode 47 is formed on the dummy pixel electrode 45 with an insulating film 48 interposed therebetween. Moreover, a first dummy common electrode 46 is formed on the opposite glass substrate 102. The dummy pixel electrode 45, the first dummy common electrode 46, the second dummy common electrode 47 and the insulating film 48 are manufactured by the same steps as those of the pixel electrode 5, the first common electrode 6, the second common electrode 7 and the insulating film 8, respectively.

These components are designed in order that the ratios of the capacitance value of the first dummy common electrode 46 to the dummy pixel electrode 45 and of the capacitance value of the second dummy common electrode 47 to the dummy pixel electrode 45 can be equal to the ratios of the capacitance value of the first common electrode 6 to the pixel electrode 5 and of the capacitance value of the second common electrode 7 to the pixel electrode 5. The first dummy common electrode 46 and the second dummy common electrode 47 are electrically connected to each other and then connected to the common electrode driver 32 as a single terminal. In addition, the dummy pixel electrode 45 is connected to the common electrode driver 32 as the other terminal.

The common electrode driver 32 is connected to such capacitor-to-be-detected 40, and automatically detects the capacitance value of the capacitor-to-be-detected 40. Since the capacitance value (liquid crystal capacitor LC or storage capacitor SC) in a unit of pixel is small (several pF), it is difficult to detect with high accuracy the capacitance value that changes for each liquid crystal panel 20. On the other hand, by use of the capacitor-to-be-detected 40 (dummy capacitor) provided separately from the pixel 1, the capacitance values of the liquid crystal capacitor LC and the storage capacitor SC of the liquid crystal panel 20 can be detected with high accuracy. In accordance with the detected capacitance values, the common electrode driver 32 sets the drive potentials VCOM 1 and VCOM 2, which are applied to the common electrodes 6 and 7, can vary.

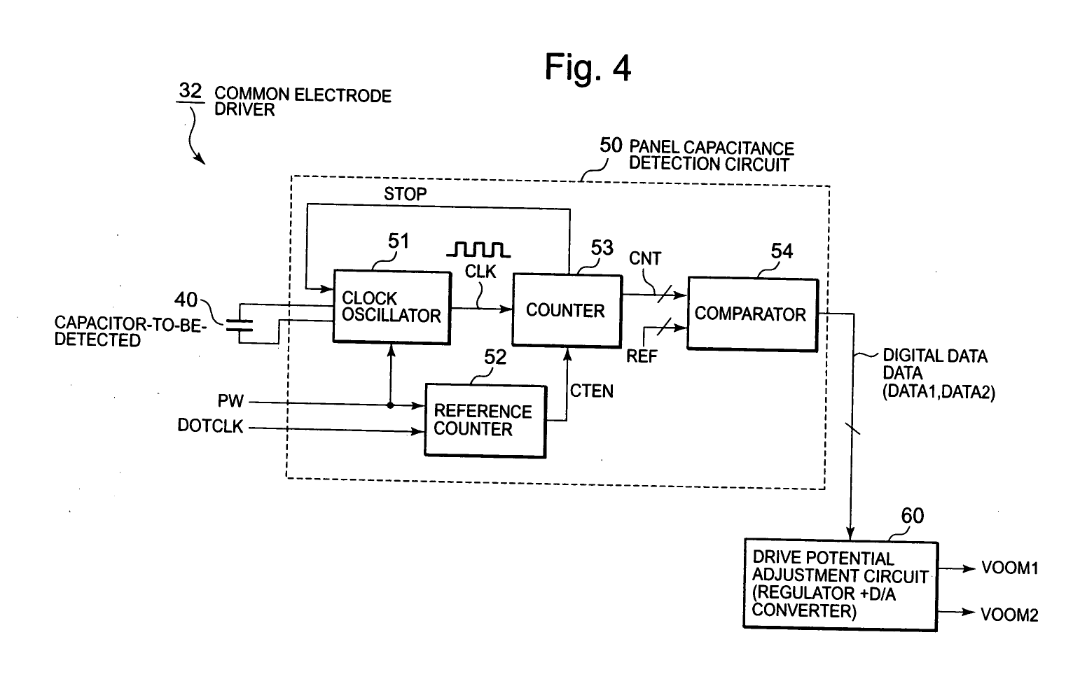

FIG. 4 shows an example of a specific configuration of the common electrode deriver 32 according to the embodiment of the present invention. The common electrode driver 32 includes a panel capacitance detection circuit 50 and a drive potential adjustment circuit 60. The panel capacitance detection circuit 50 is connected to the capacitor-to-be-detected 40 of the liquid crystal panel 20, and detects the capacitance values of the liquid crystal capacitor LC and the storage capacitor SC. In accordance with the capacitance value detected by the panel capacitance detection circuit 50, the drive potential adjustment circuit 60 adjusts the drive potentials VCOM 1 and VCOM 2. Once the combination of the liquid crystal panel 20 and the liquid crystal panel drive IC 30 is determined, the capacitance of a panel does not frequently change. Thus, the drive potentials of the common electrodes 6 and 7, which correspond to the capacitance value of the panel, may be adjusted only once when the power is turned on, for example.

As shown in FIG. 4, the panel capacitance detection circuit 50 includes a clock oscillator 51, a reference counter 52, a counter 53 and a comparator 54.

The clock oscillator 51 is connected to the capacitor-to-be-detected 40. The clock oscillator 51 creates a triangular waveform through charge and discharge to the capacitor-to-be-detected 40 and creates an oscillator clock signal CLK on the basis of the triangular waveform. The frequency of the oscillator clock signal CLK changes in accordance with the capacitor value of the capacitor-to-be-detected 40. The smaller the capacitance value of the capacitor-to-be-detected 40 is, the larger the frequency of the oscillator clock signal CLK becomes. This clock oscillator 51 is activated in response to a power ON signal PW, which turns on the liquid crystal panel drive IC 30.

The reference counter 52 is activated in response to the power ON signal PW. This reference counter 52 receives a source oscillator clock signal DOTCLK of the liquid crystal display device 10 and also outputs a counter enable signal CTEN, which activates the counter 53. To be more specific, the reference counter 52 counts the number of pulses of the source oscillator clock signal DOTCLK the predetermined number of times and activates the counter enable signal CTEN only for a period of time during which the reference counter 52 counts the number of pulses of the source oscillator clock signal DOTCLK. Specifically, it can be said that the reference counter 52 is provided to define a “predetermined period of time” during which the counter 53 is activated.

The counter 53 receives the oscillator clock signal CLK from the clock oscillator 51 and also receives the counter enable signal CTEN from the reference counter 52. Then, the counter 53 is activated only for the “predetermined period of time” during which the counter enable signal CTEN is activated. The counter 53 thus counts the number of pulses of an oscillator clock signal CLK only for the “predetermined period of time.” When the counter enable signal CTEN is deactivated, an oscillator stop signal STOP instructing the stop of the clock oscillation is outputted from the counter 53 to the clock oscillator 51. Moreover, a count value CNT indicating the number of pulses counted during the predetermined period of time is outputted from the counter 53 to the comparator 54.

The smaller the capacitance value of the capacitor-to-be-detected 40 is, the larger the frequency of the oscillator clock signal CLK becomes, and the larger the count value CNT of the predetermined period of time becomes. On the other hand, the larger the capacitance value of the capacitor-to-be-detected 40 is, the smaller the frequency of the oscillator clock signal CLK becomes, and the smaller the count value CNT of the predetermined period of time becomes. A count value CNT in the case of a standard capacitor-to-be-detected 40 is calculated at the time of designing the circuit and stored within the circuit as a predetermined reference value REF. Accordingly, the comparator 54 can determine the capacitance value of the capacitor-to-be-detected 40 by comparing the count value CNT with the reference value REF. The comparator 54 outputs digital data DATA corresponding to the result of comparison to the drive potential adjustment circuit 60. The digital data DATA is a control signal indicating the drive potentials VCOM 1 and VCOM 2 in accordance with the determined capacitance value of the capacitor-to-be-detected 40, and is a control signal instructing the drive potential adjustment circuit 60 to adjust the drive potentials VCOM 1 and VCOM 2. It should be noted that in a case where the drive potentials VCOM 1 and VCOM 2 are to be separately and independently adjusted, the digital DATA includes digital data DATA1 for adjusting the drive potential VCOM 1, and digital data DATA2 for adjusting the drive potential VCOM 2.

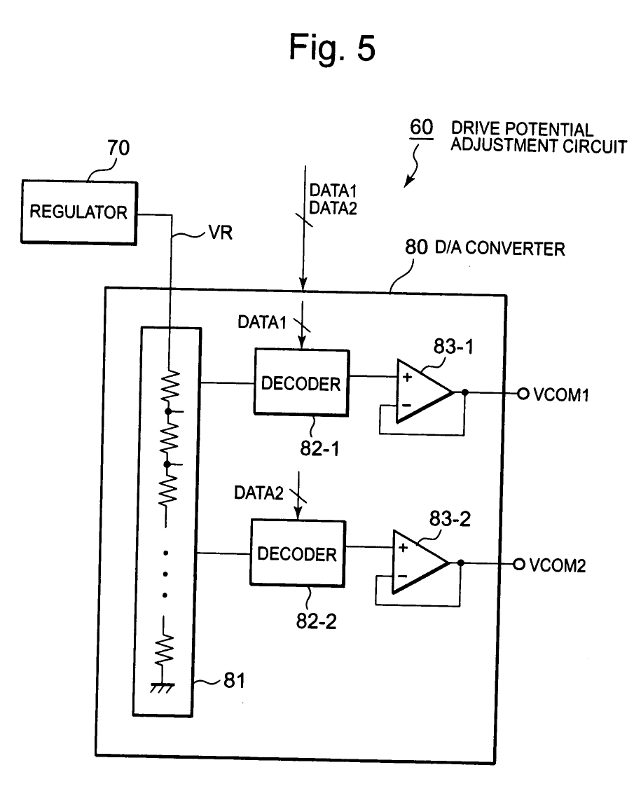

FIG. 5 is a diagram showing an example of a configuration of the drive potential adjustment circuit 60 according to the present embodiment. The drive potential adjustment circuit 60 includes a regulator 70 and a D/A converter 80. The regulator 70 is a potential creation circuit, which creates and outputs a predetermined potential VR. The D/A converter 80 receives the output potential VR of the regulator 70 and the aforementioned digital data DATA (DATA 1 and DATA 2). On the basis of the output potential VR of the regulator 70, this D/A converter 80 creates drive potentials VCOM 1 and VCOM 2 corresponding to the received digital data DATA (DATA 1 and DATA 2).

Specifically, the D/A converter 80 includes a resistor dividing circuit 81, decoders 82-1 and 82-2, and voltage followers 83-1 and 83-2. The resistor dividing circuit 81 is configured of a plurality of resistors connected to one another in series. One end of the resistor dividing circuit 81 is connected to the output of the regulator 70, and the other end thereof is connected to the ground. Accordingly, the resistor dividing circuit 81 can generate a plurality of reference potentials between the output potential VR of the regulator 70 and the ground potential by means of resistor division. The decoder 82-1 selects one reference potential corresponding to the digital data DATA 1 from the plurality of reference potentials. The selected potential is outputted as the drive potential VCOM 1 via the voltage follower 83-1. Likewise, the decoder 82-2 selects one reference potential corresponding to the digital data DATA 2 from the plurality of reference potentials. The selected potential is outputted as the drive potential VCOM 2 via the voltage follower 83-2.

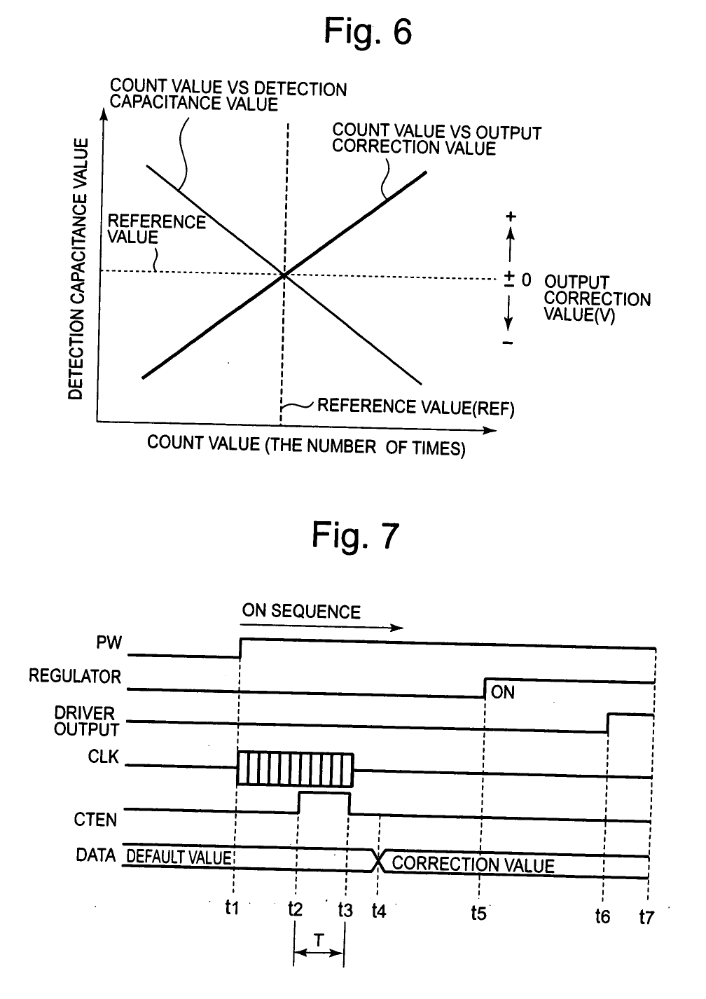

As described above, the drive potential adjustment circuit 60 adjusts (corrects) the drive potentials VCOM 1 and VCOM 2 of the common electrodes 6 and 7 from the common electrode potential (the reference value of the common electrode potential) after the offset value for the capacitance value to become the reference value is applied. FIG. 6 shows an example of relationships of the adjustment values (correction values) of the drive potentials VCOM 1 and VCOM 2, the capacitance value of the capacitor-to-be-detected 40 and the count value CNT. The reference value of the capacitor-to-be-detected 40 is indicated by a broken line in a horizontal direction. The reference value REF of the count value CNT is indicated by a broken line in a vertical direction. As shown in FIG. 6, as the count value CNT becomes larger than the reference value REF, the drive potentials VCOM 1 and VCOM 2 are set higher. Specifically, as the capacitance value of the capacitor-to-be-detected 40 becomes smaller, the drive potentials VCOM 1 and VCOM 2 are set higher.

FIG. 7 is a timing chart showing an operation of the common electrode driver 32 according to the present embodiment. At a time t1, the power ON signal PW is activated, and the liquid crystal panel drive IC 30 is thus started. Consequently, the common electrode driver 32 is started as well and the clock oscillator 51 starts the creation of an oscillator clock signal CLK. It should be noted that digital data DATA (DATA 1 and DATA 2) for adjusting the drive potentials VCOM 1 and VCOM 2 are set at default values at this time.

At a time t2, which is the time after the operation of the clock oscillator 51 becomes stable, the reference counter 52 activates the counter enable signal CTEN. In response to this, the counter 53 starts counting the number of pulses of the oscillator clock signal CLK. At a time t3, which is the time after the predetermined time period T starting from the time t2 has passed, the reference counter 52 deactivates the counter enable signal CTEN. In response to this, the counter 53 stops counting the number of pulses. At the same time, the operation of the clock oscillator 51 stops in accordance with the oscillator stop signal STOP.

The count value CNT indicating the number of pulses counted by the counter 53 during the predetermined time period T is outputted to the comparator 54. The comparator 54 detects the capacitance value of the capacitor-to-be-detected 40 by comparing the count value CNT with the reference value REF. Then, on the basis of the detected capacitor value, the comparator 54 determines digital data DATA for adjusting a drive potential. At a time t4, the digital data DATA to be inputted to the drive potential adjustment circuit 60 is changed from the default value to the value after the correction is made.

At a time t5, the regulator 70 is activated and outputs the predetermined output potential VR. The D/A converter 80 converts the output potential VR into the drive potentials VCOM 1 and VCOM 2, which correspond to the digital data DATA after the correction is made. At a time t6, the common electrode driver 32 applies the drive voltage potentials VCOM 1 and VCOM 2 respectively to the first and second common electrodes 6 and 7. At a time t7, an image is displayed on the liquid crystal panel 20.

As has been described above, the panel capacitance detection circuit 50, which detects the capacitance values of the liquid crystal capacitor CL and the storage capacitor SC of the liquid crystal panel 20, is embedded in the common electrode driver 32 (liquid crystal panel drive IC 30) according to the present invention. The drive potentials VCOM 1 and VCOM 2 to be applied to the common electrodes 6 and 7 are automatically adjusted on the basis of the capacitance values detected by the embedded panel capacitance detection circuit 50. In other words, by installing in a versatile manner the common electrode driver 32 having the aforementioned configuration in the liquid crystal display device 10, the drive potentials VCOM 1 and VCOM 2 in each liquid crystal panel 20 can be automatically adjusted. In this case, it is not necessary to determine digital data and then to store the data in a ROM in advance for each liquid crystal panel 20. In addition, the drive potentials VCOM 1 and VCOM 2 of the common electrodes 6 and 7 can be efficiently adjusted for each liquid crystal panel 20, and no extra work process is required. Moreover, since the drive potentials VCOM 1 and VCOM 2 of the common electrodes 6 and 7 are adjusted, irregularities of display characteristics among liquid crystal panels 20 can be suppressed. As a result, the production yields can be improved. Furthermore, the most appropriate driving of a liquid crystal cells can be realized.

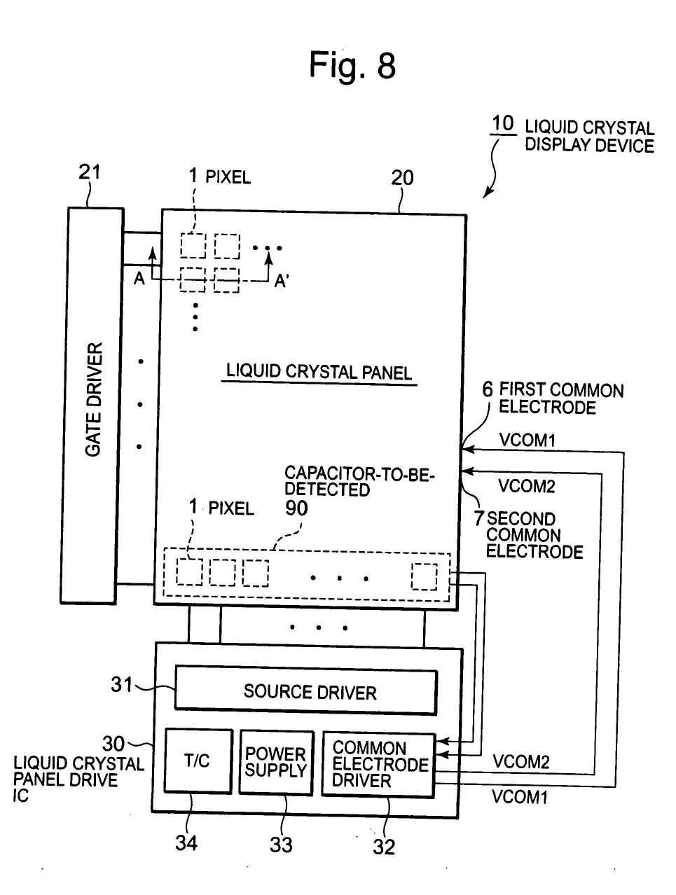

FIG. 8 shows a modification example of the liquid crystal display device 10 according to the present embodiment. In the modification example, instead of using the aforementioned capacitor-to-be-detected 40, a capacitor-to-be-detected 90 is used for detecting the capacitance values of the liquid crystal capacitor LC and the storage capacitor SC of the liquid crystal panel 20. This capacitor-to-be-detected 90 is composed of some of the pixels 1 in the liquid crystal panel 20. For example, the capacitor-to-be-detected 90 is composed of all of the pixels 1 connected to one gate line 3. When the capacitor-to-be-detected 90 is made, one gate line 3 is driven, and also the data line 4 to be connected to pixels 1 constituting the capacitor-to-be-detected 90 is short-circuited by an unillustrated short circuit line. The common electrode driver 32 is connected to the short circuit line and the first common electrodes 6 and 7. Similar to the case of the capacitor-to-be-detected 40, the common electrode driver 32 automatically detects the capacitance value of the capacitor-to-be-detected 90. Then, the common electrode driver 32 sets, the drive potentials VCOM 1 and VCOM 2 to be applied to the common electrodes 6 and 7, to vary in accordance with the detected capacitance value.

In the case of the modification example, the same effects as those of the case in the aforementioned embodiment can be obtained. Furthermore, as effects specific to the modification example, the following effects can be cited. The capacitance of the same layout size as that of the actual pixel is detected. Then, a fringe effect in an edge of the capacitor element to be measured can be made the same as that of the actual pixel. As a result, the detection of a capacitance value with high accuracy is made possible. In addition, a pixel utilized to display an image is used as the capacitor-to-be-detected. Then, it is not necessary to prepare the area on the display panel for forming a dummy capacitor. Thus, it is made possible to provide a liquid crystal display panel at lower costs.

What is claimed is:

1. A drive circuit, which drives a liquid crystal panel having a plurality of pixels, comprising:
a panel capacitance detection circuit configured to detect the capacitance values of a liquid crystal capacitor and a storage capacitor of the liquid crystal panel; and
a drive potential adjustment circuit configured to set a drive potential, which are to be applied to common electrodes provided in common for the plurality of pixels, according to the detected capacitance values.

2. The drive circuit according to claim 1, wherein the panel capacitance detection circuit includes:
a clock oscillator configured to create a clock signal the frequency of which changes in accordance with the capacitance values;
a counter configured to count the number of pulses of the clock signal for a predetermined period of time; and
a comparator configured to compare a reference value with the number of pulses counted during the predetermined period of time, and
wherein the panel capacitance detection circuit detects the capacitance values on the basis of the result of the comparison.

3. The drive circuit according to claim 2, wherein
the panel capacitance detection circuit outputs digital data indicating the result of the comparison to the drive potential adjustment circuit, and
the drive potential adjustment circuit includes:
a potential creation circuit configured to create a predetermined potential; and
a D/A converter configured to create the drive potentials based on the predetermined potentials in accordance with the digital data.

4. The drive circuit according to claim 2, wherein the drive potential adjustment circuit sets the drive potentials higher as the number of pulses counted during the predetermined period of time becomes larger than the reference value.

5. A liquid crystal display device, comprising:
a liquid crystal panel including a plurality of pixels;
and
a drive circuit configured to apply drive potentials to common electrodes provided in common for the plurality of pixels,
wherein the drive circuit includes a panel capacitance detection circuit configured to detect the capacitance values of a liquid crystal capacitor and a storage capacitor of the liquid crystal panel, and the drive potentials are varied according to the detected capacitance values.

6. The liquid crystal display device according to claim 5, wherein the drive circuit sets the drive potentials higher as the detected capacitance values become smaller.

7. The liquid crystal display device according to claim 6, wherein
in addition to the plurality of pixels, the liquid crystal panel includes, a dummy capacitor formed on a glass substrate, and
the drive circuit is connected to the dummy capacitor and sets the drive potential to vary according to the capacitance value of the dummy capacitor.

8. A driver for driving a liquid crystal display, said liquid crystal display including a plurality of pixel elements, each containing a thin film transistor (TFT), a liquid crystal cell coupled to said TFT and a storage capacitor coupled to said TFT, said liquid crystal display further including a first common electrode coupled to said liquid crystal cells of said plurality of pixel elements and a second electrode coupled to said storage capacitors of said plurality of pixel elements, comprising:
a first terminal receiving a capacitance value of said liquid crystal panel and said storage capacitor; and
a second terminal supplying drive voltages to said first and second common electrodes, said drive voltages being adjusted by said capacitance value received at said first terminal.

9. The driver as claimed in claim 8, said driver further comprising:
a source driver driving a data lines coupled to said TFT;
a common electrode driver coupled to said first and second terminals.

10. The driver as claimed in claim 9, wherein
wherein common electrode driver comprises a capacitance detection circuit outputting a digital data based on said capacitance value and a drive voltage adjustment circuit responding to said digital data to output the adjusted drive voltages.
